(19) United States
(12) Patent Application Publication
(10) Pub. No.: US 2026/0037676 A1
(43) Pub. Date: Feb. 5, 2026

(54) Invitation-Less Unauthenticated Software Application Access

(71) Applicant: Zoom Communications, Inc., San Jose, CA (US)

(72) Inventors: Evgeny Balashov, Burbank, CA (US); Brendan James Ittelson, San Jose, CA (US); Arun Janakiraman, San Francisco, CA (US); Ross Douglas Mayfield, Palo Alto, CA (US)

(21) Appl. No.: 18/790,666

(22) Filed: Jul. 31, 2024

(51) Int. Cl. G06F 21/62

(52) U.S. Cl. CPC G06F 21/629; G06F 2221/2141

(57) ABSTRACT

The invitation-less and unauthenticated access to software applications is enabled at client devices, thereby allowing device users to access and use software applications without initiating an authentication process such as OAuth. A client device of a first device user who is unauthenticated to a software application transmits a request to access the software application within a client application at the client device. The client application then accesses the software application based on the request, based on the first device user being unauthenticated to the software application, and independent of an invitation to access the software application from a second device user who is authenticated to the software application.

### FIELD

This disclosure generally relates to the unauthenticated access of device users to software applications, and, more specifically, to enabling the invitation-less and unauthenticated access to software applications at user devices.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of software application access system as part of an electronic computing and communications system.

FIG. 6 is a block diagram of examples of a system for invitation-less unauthenticated software application access.

FIG. 7 is a flowchart of an example of a client-side technique for invitation-less unauthenticated software application access.

FIG. 8 is a flowchart of an example of a server-side technique for invitation-less unauthenticated software application access.

### DETAILED DESCRIPTION

Modern computing platforms allow software users to access and use a variety of first- and third-party software applications, commonly referred to as “apps.” These software applications may have a wide range of functionalities including, for example, productivity, communication, entertainment, integration, or like tools. Access to the applications which are generally available for users of a given platform may be facilitated via an application marketplace specific to the platform or shared by multiple platforms. For example, users of the iOS platform may use the Apple® App Store to download mobile applications onto their mobile phones or tablet computers. In another example, users of the Android platform may use the Google® Play Store to download applications onto their mobile phones, tablet computers, or televisions. In yet another example, a productivity and communication software platform, such as a unified communications as a service (UCaaS) platform as provided by Zoom®, may include its own application marketplace from which applications may be accessed.

Generally, to access and use an application available via an application marketplace, a software user initiates an installation process using a web protocol for authenticating the user and authorizing the use of permission scopes on behalf of the user. One popular example of such a protocol is that of the open authorization open standard for access delegation, commonly referred to as “OAuth.” The permission scopes correspond to user granted permissions for a given application to use aspects of the device of the user or of software running thereon, for example, profile and contact information of the user, a calendar of the user, device settings and information, input capture components such as a camera and/or microphone, read and/or write functionality for device memory, or the like. Device usage facilitated via such permission scopes may be enabled using client-side application programming interfaces (APIs), a software development kit (SDK), server-side approaches such as Representational State Transfer (REST) APIs and/or webhooks, or the like. These authentication processes are established and used to ensure users are informed as to what applications can do with their data and devices and to protect application developers by obtaining user authorization for such application activity.

Some software platforms that include application marketplaces may also make application access available in one or more other ways. For example, a UCaaS platform that provides conferencing software for facilitating video-enabled conferences between participants in multiple locations may enable users of the conferencing software to access and use applications directly from a graphical user interface (GUI), such as a toolbar, available within and during a video conference. In particular, a participant of the video conference may access an application toolbar within the video conference experience and complete an authentication process for an application to enable use of the application during the video conference and/or for later use after the video conference has ended. This authentication process may be the same as or substantially similar to that performed via the application marketplace of the UCaaS.

However, the user experience for authenticating a user for application access during a video conference may differ based on whether the user is already authenticated with respect to the UCaaS platform. In particular, some users of video conferencing software of a UCaaS platform may be authenticated (e.g., registered) with the UCaaS platform while others may be unauthenticated (e.g., unregistered). For example, unauthenticated users may access individual video conferences using encrypted uniform resource locators (URLs) embedded within calendar events or linked within written communications such as emails. This ease of access is a design choice set forth by the software platform to allows these unauthenticated users to simply clicking on a URL to conveniently participate in synchronous audiovisual communications. A user who is already authenticated with the software platform may be allowed to immediately begin an authentication process for a given application during the video conference, while a user who is not may first need to create or otherwise log into an account of the software platform, leading to additional requirements and thus video conference disruption.

To preserve ease of user access to platform functionality in view of this, recent approaches in the UCaaS platform space have implemented a “guest mode” feature for enabling unauthenticated users to access applications during a video conference. Specifically, this guest mode feature enables a participant of a video conference, who is already authenticated with respect to a given application, to invite another participant of the same video conference, who is not authenticated with respect to the application, to access the application during the video conference, provided the application enables such guest mode access. For example, assume that a software user named Alice is already be authenticated for a “Project Schedule” application before joining a video conference, while their colleague Bob is not. During a video conference, Bob realizes that he is unable to use the Project Schedule application because he has not yet installed it (i.e., been authenticated to access it). Alice, recognizing that the Project Schedule application enables guest mode access, accordingly sends Bob an invitation within the video conference to enable Bob to have guest mode access to the application. The Project Schedule application, upon receiving a request from Bob's device to access it, validates that Bob is in an active video conference with Alice and that Alice is authenticated to the application. Bob is accordingly granted guest mode access to the application, thereby gaining access to functionality of the application while Bob remains in the video conference.

Nevertheless, this guest mode feature still has technical limitations that create friction in the application use experience. In particular, the guest mode feature is limited to situations in which an authenticated user (i.e., a software user who is already authenticated for an application and thus has already completed the authentication process for it) invites an unauthenticated user (i.e., a software user who has not yet been authenticated for an application and thus has not yet completed the authentication process for it) during a video conference. This limitation prevents unauthenticated users from accessing an application without being invited by an authenticated user and outside of that specific video conference. Ultimately then, an unauthenticated user may have no opportunity to try out an application without being invited and outside of a video conference experience. In many cases, these technical limitations, in concert with the user experience friction typically introduced by the standard application authentication process, will preclude new potential application users from ever accessing and using many applications available within an application marketplace.

Implementations of this disclosure address problems such as these using an “instant apps” mode by which invitation-less unauthenticated software application access is enabled for software users. In particular, the instant apps mode according to the implementations of this disclosure enable a software user to access some or all functionality of a software application from one or more of various entry points without requiring the software user to first initiate or complete an authentication process for the software application and without requiring that the software user be invited to access the software application by another software user who is already authenticated to the software application. This instant apps mode accordingly enables a frictionless user experience for users of a software platform to access and use configured software applications on their own time and in any event prior to deciding to go through an authentication process.

An application developer that creates a software application for publication at a software platform application marketplace, or otherwise for use with the software platform, configures the software application for instant apps mode access. Thereafter, a software user, also referred to as a device user, who is unauthenticated to a software application, may desire to try the software application in the instant apps mode. A client device of the software user transmits a request to access the software application within a client application running at the client device. The client application is client-side software of the software platform that may be used to interface with one or more software services of the software platform, for example, video conferencing software of the software platform or an application marketplace of the software platform. The request is received by a server of the software platform and processed to enable access to the software application at the client device. Thus, the client application accesses the software application based on the request, based on the software user being unauthenticated to the software application, and independent of an invitation to access the software application from a different software user who is authenticated to the software application. The software application accessed in the instant apps mode (i.e., in an invitation-less unauthenticated manner) may be a web application which features functionality that is not entirely contained within a package downloadable to a user device or another client application which may be locally run at a user device in connection with server-side processing at a remote server.

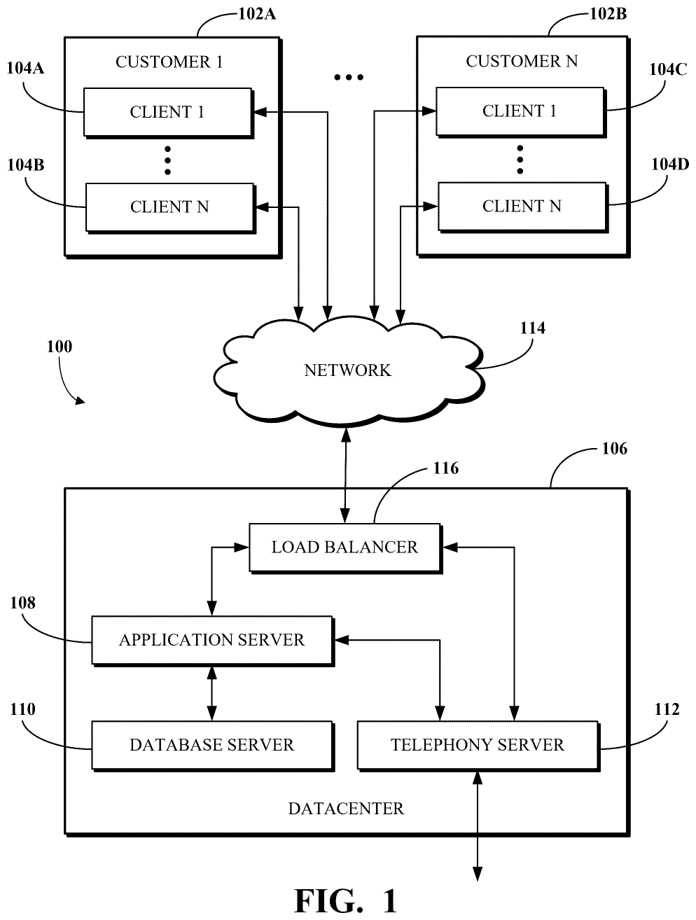

To describe some implementations in greater detail, reference is first made to examples of hardware and software structures used to implement a system for invitation-less unauthenticated software application access. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

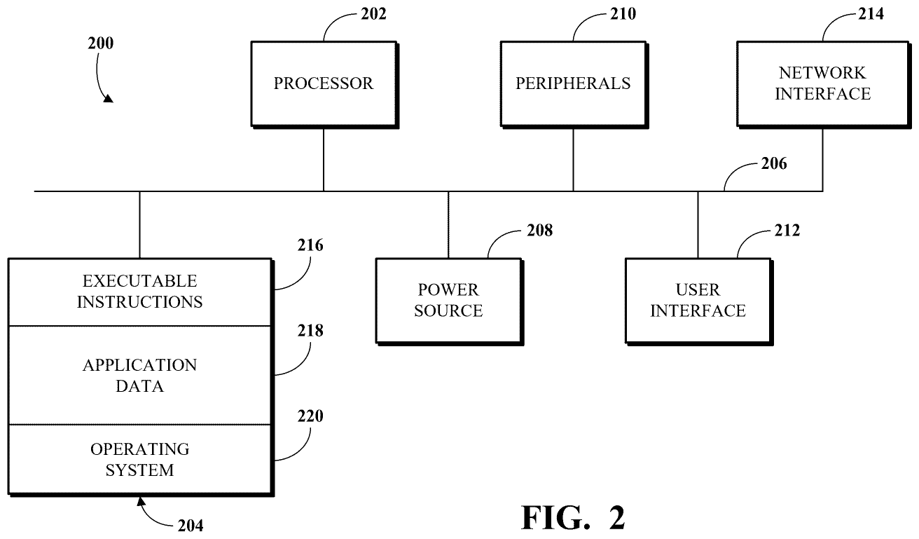

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

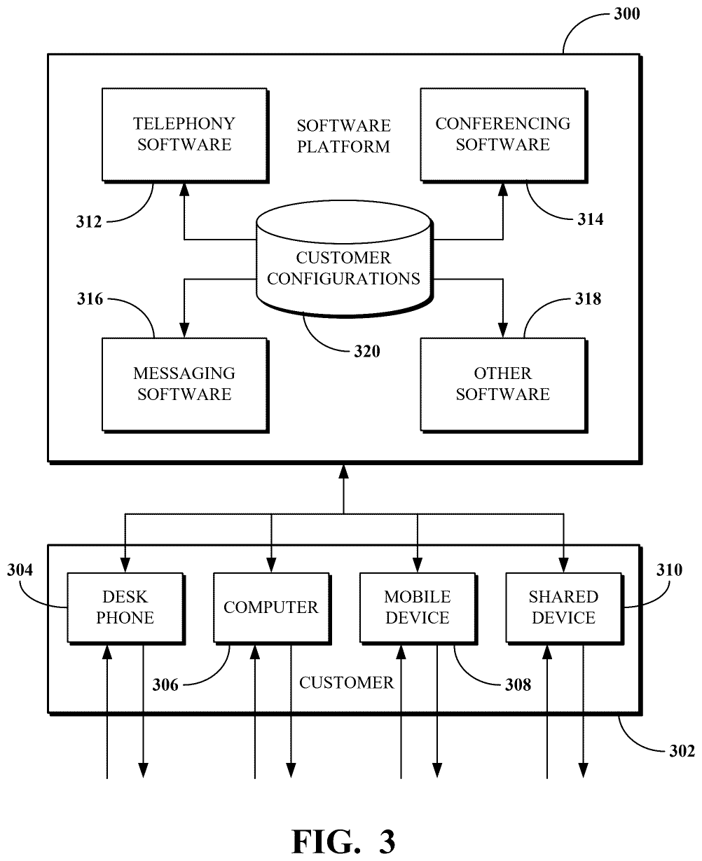

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include an application marketplace from which users of the software platform 300, via ones of the clients 304 through 310, can access software applications published for otherwise in connection with the software platform 300.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

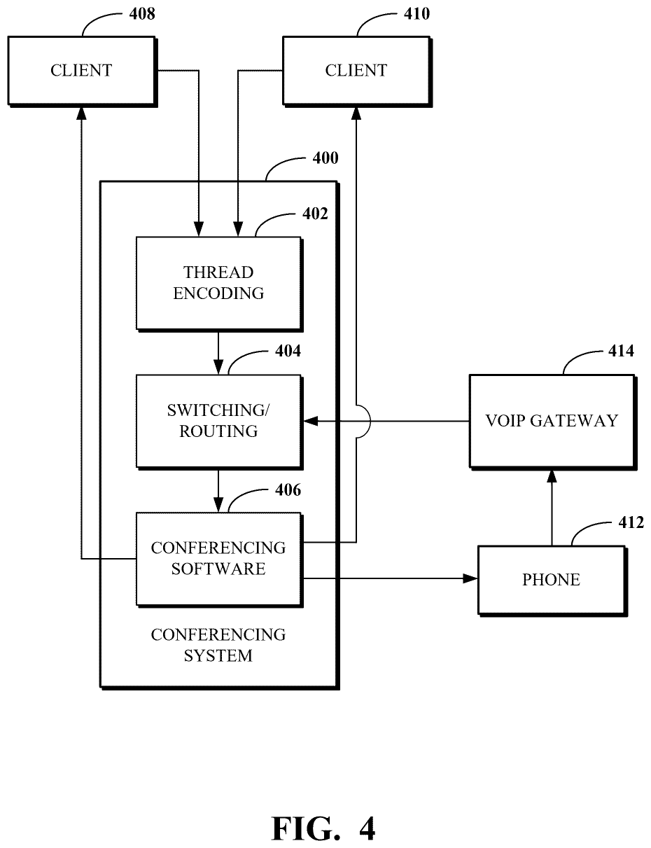

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

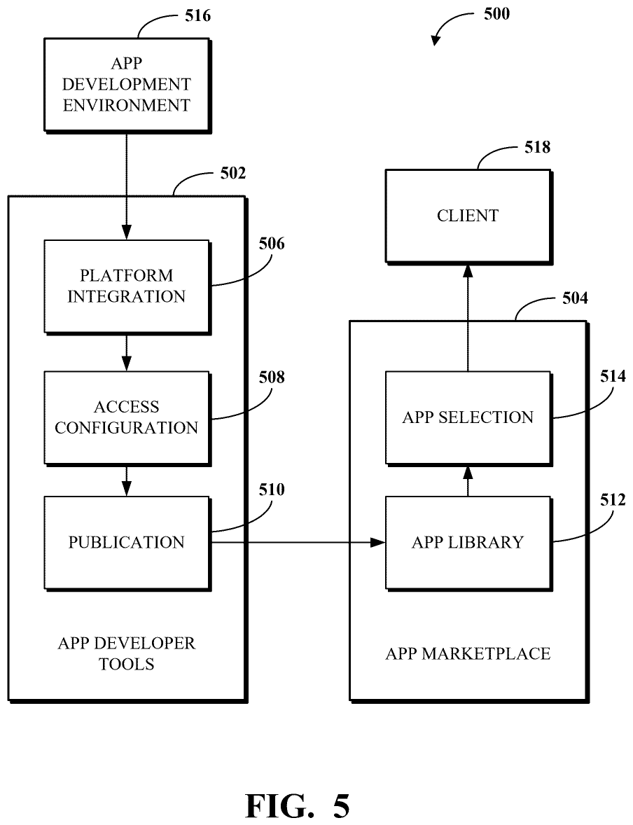

FIG. 5 is a block diagram of an example of software application access system 500 as part of an electronic computing and communications system, for example, the system 100 shown in FIG. 1. In particular, the system 500 includes app (i.e., application) developer tools 502 which correspond to server-side software functionality used by application developers to prepare their software applications for publication with a software platform, such as the software platform 300 shown in FIG. 3, as well as an app (i.e., application) marketplace 502 to which such software applications are published for access by users of the software platform. As shown, the app developer tools 502 include a platform integration tool 506, an access configuration tool 508, and a publication tool 510, and the app marketplace 504 includes an app library 512 and an app selection tool 514. The components of the app developer tools 502 and of the app marketplace 504 are shown and described herein by example and thus are non-limiting in their specific form, arrangement, and/or content.

A software application is developed at or otherwise using an app development environment 516. The app development environment 516 generally refers to and includes hardware and software involved in the development of the software application, for example, servers, user devices, an integrated development environment (IDE), a SDK, APIs, and/or the like. Such hardware and software connect to and use the app developer tools 502 to prepare the software application for publication within the app marketplace 504.

A computing device of the app development environment 516 uses the platform integration tool 506 to conform the software application to architectural and like design requirements and preferences of the software platform. For example, the platform integration tool 506 may be used to assert an OAuth protocol for users, configure secure headers within the application code, define processes for communicating requests with the software platform, cause localized installation of the software application at client devices, define roles and permissions for users and the software platform, indicate app context parameters for controlling the execution context for the software application, coordinating user experiences of the software application and the software platform, identifying software platform services with which the software and/or the like. In some cases, the platform integration tool 506 may also include functionality for facilitating a testing of the software application within the software platform.

The computing device of the app development environment 516 uses the access configuration tool 508 to define user access controls for the software application. In particular, the access configuration tool 508 may present or otherwise include one or more selectable configurations for enabling various user access to the software application. Non-limiting examples of such access include access under a guest mode and access under an instant apps mode. For example, a developer using the computing device of the app development environment 516 may use the access configuration tool 508 to configure the software application for use in the instant apps mode, thereby enabling the invitation-less unauthenticated access by users to the software application.

The computing device of the app development environment 516 uses the publication tool 510 to cause a deployment of instructions, data, packaged contents, and/or the like to the app marketplace 504 for publication within the app library 512. For example, the publication tool 510 may include a user interface element that, when selected by a user of the computing device of the app development environment 516, cause the software application to be added to the app library 512. In at least some cases, a review process may be performed by the software platform prior to completing the publication of the software application to the app library 512. In some cases, rather than to publish the software application to the app library 512, the publication tool 510 can be used to publish the software application to an unlisted applications library at which the software application may be inaccessible to the general public, a beta applications library at which the software application may be tested by users who are provided with an authorization URL for the software application, or to a private applications library accessible only to other users within a same software platform account as the user of the computing device of the app development environment 516.

The app library 512 represents a collective set of software applications which have been published to the app marketplace 504 for user access. The app library 512 may include multiple pages each corresponding to different subsets of the software applications according to various categories (e.g., newest, most popular, productivity tools, etc.) or a single page listing all software applications. Users, such as a user of a client 518 (e.g., a client device), may access the app library 512 from one of multiple entry points, including within a dedicated app marketplace window of a client application running on their user devices (i.e., client devices) or within a GUI providing app marketplace 504 integration within a software service of the software platform, such as a GUI toolbar of video conferencing software.

The client 518 thus uses the app library 512 to browse software applications available for access. The client 518 uses the app selection tool 514 to select a software application from the app library 512 for installation. Selecting a software application for installation using the app selection tool 514 includes a user of the client 518 interacting with a user interface element of the app marketplace 504 that is associated with the software application (e.g., a box on an app library 512 page associated with the software application), for example, by clicking on the user interface element using a mouse or tapping on the user interface element via a touch screen display. Interacting with the user interface element causes a web browser embedded within the client application running at the client 518 to transmit a request to a webpage associated with the software application. The request is a request to access the software application via the webpage. The request may be presented via a URL accessed by the embedded web browser. The webpage is typically external to the software platform; however, in some cases, the webpage may be a webpage of or otherwise associated with the software platform.

The interactive user interface element for installing a software application may indicate a particular mode for installing the software application, for example, the general installation in which a user of the client 518 initiates and completes an authentication process to gain access to all functionality of the software application or an instant apps mode in which the user of the client 518 gains access to a subset of the functionality of the software application without having to initiate or otherwise complete an authentication process for the software application. For example, the user interface element may include the text “Install” or “Add” for the general installation or the text “Try Now” or “Open” for the instant apps mode. In some cases, the user interface element presented for the software application, and thus the text on that user interface element, may be based on a signed in status of the user of the client 518. For example, where the user is signed into the software platform and thus presently authenticated for the software platform, the user interface element may default to the general installation. In another example, where the user is not signed into the software platform (or has not yet created an account with the software platform) and thus is not presently authenticated for the software platform, the user interface element may default to the instant apps mode. In some cases, multiple user interface elements may be present each corresponding to a different installation option (e.g., a first box for the general installation and a second for the instant apps mode).

Upon selection of the software application including the processing of a request transmitted from the client 518, the client 518 may access the software application and use functionality thereof that corresponds to the manner of access. For example, where the software application is accessed in the instant apps mode, the client application running on the client 518 may have access to a subset of functionality of the software application. In some cases, the subset of functionality to which the client 518 has access via the instant apps mode may correspond to a subset of functionality defined for use with a guest mode feature for which the software application is also configured. In this way, device users who access the software application in the guest mode or in the instant apps mode may have a same or similar user experience while using the software application. While selection of the software application is described in FIG. 5 as being via the app marketplace 504, in some cases, as will be described in further detail below, the software application may instead be selected from one of multiple entry points within or external to the software platform.

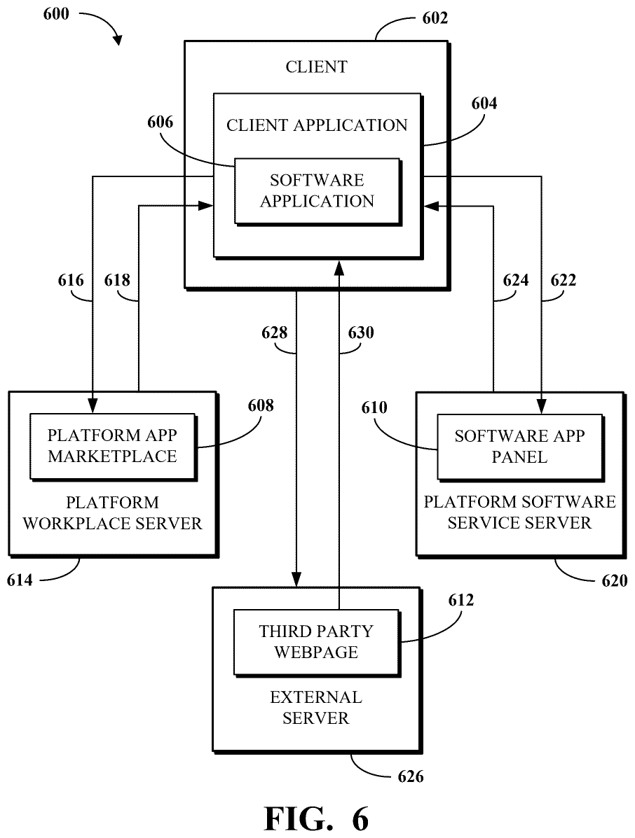

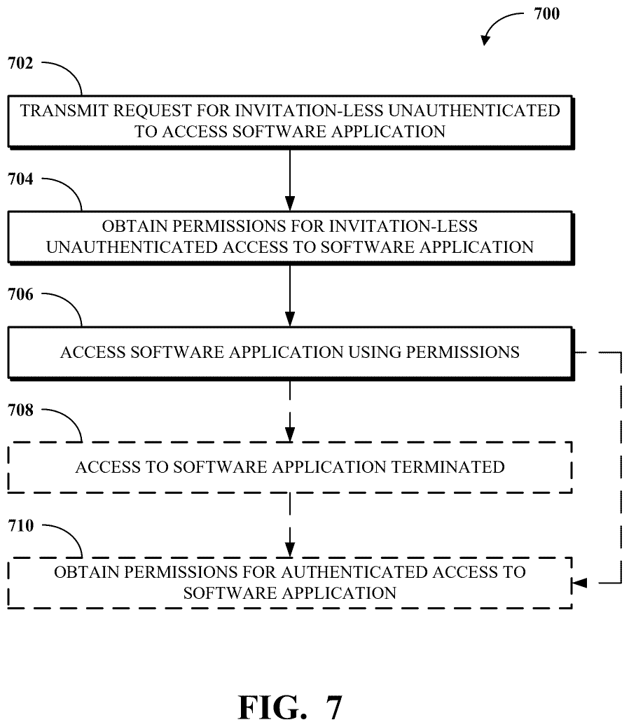

Further disclosure of processes performed for invitation-less unauthenticated software application access will now be described with respect to FIGS. 6 and 7. FIG. 6 is a block diagram of examples of a system 600 for invitation-less unauthenticated software application access. The system 600 includes a client 602 running a client application 604 that has access to a software application 606 in an instant apps mode (i.e., without invitation or authentication of the user of the client 602 to the software application 606), and various example entry points for the access of the software application 606. In particular, the example entry points include a platform app marketplace 608, a software app panel 610, a third party website 612.

The platform app marketplace 608, which may, for example, be the app marketplace 504 shown in FIG. 5, includes an app library (e.g., the app library 512 shown in FIG. 5) at which selections of software applications including the software application 606 may be browsed within the client application 604. For example, the client application 604 may include an “Apps” tab via which a user of the client 602 can access the platform app marketplace 608 to locate the software application 606 for invitation-less unauthenticated access at the client 602. The platform app marketplace 608 is implemented by a platform workplace server 614, which is a server of the software platform with which the client application 604 is associated (e.g., the software platform 300 shown in FIG. 3).

To obtain invitation-less unauthenticated access to the software application 606 via the platform app marketplace 608, the client application 604 transmits a request 616 (e.g., a GET HTTP request) using a web browser embedded within the client application 604 to the platform app marketplace 608. The platform workplace server 614, in response to the request 616, transmits a response 618 to the client application 604 to configure the client application 604 to have invitation-less unauthenticated access to the software application 606. The request 616 and the response 618 thus enable access to the software application 606 at the client 602 without a user of the client 602 initiating or otherwise completing an authentication process for the software application 606.

The software app panel 610 is a GUI panel available within a software service of the software platform, for example, video conferencing software (e.g., the conferencing software 314 shown in FIG. 3), within which selections of software applications including the software application 606 may be browsed or otherwise within which some or all of the software applications of the platform app marketplace 608 may be browsed within the software service environment. For example, a GUI of the software service may include an “Apps” tab via which a user of the client 602 can access the software app panel 610 to locate the software application 606 or invitation-less unauthenticated access at the client 602. The software app panel 610 is implemented by a platform software service server 620, which is a server of the software platform with which the client application 604 is associated. In some cases, the platform software service server 620 and the platform workplace server 614 may be the same server. In some cases, one or both of the platform workplace server 614 or the platform software service server 620 may be multiple servers.

To obtain invitation-less unauthenticated access to the software application 606 via the software app panel 610, the client application 604 transmits a request 622 (e.g., a GET HTTP request) using a web browser embedded within the client application 604 to the software app panel 610. The platform software service server 620, in response to the request 622, transmits a response 624 to the client application 604 to configure the client application 604 to have invitation-less unauthenticated access to the software application 606. In particular, the platform software service server 620 may relay the request 622 to the platform workspace server 614 for processing and may relay a response from the platform workspace server 614 as the response 624 to the client application 604. The request 622 and the response 624 thus enable access to the software application 606 at the client 602 without a user of the client 602 initiating or otherwise completing an authentication process for the software application 606.

The third party webpage 612 is a webpage which may be accessed and rendered within a web browser, for example, a standalone web browser running at the client 602 or a web browser embedded within the client application 604. The third party webpage 612 is implemented using an external server 626 which is external to the software platform with which the client application 604 is associated. For example, the third party webpage 612 may be accessed by a user of the client 602 manually typing a URL at which the third party webpage 612 is accessed within an address bar of the web browser or by clicking on a hyperlink for the URL. To obtain invitation-less unauthenticated access to the software application 606 via the third party webpage 612, the user of the client 602 interacts with a user interface element of a GUI of the third party webpage 612. Interaction with the user interface element causes the client 602, via the web browser accessing the third party webpage 612, to transmit a request 628 (e.g., a GET HTTP request) to the third party webpage 612. The external server 626, in response to the request 628, transmits a response 630 to the client 602 via the web browser accessing the third party webpage 612 to configure the client 602 to open the client application 604 or, if already open, to cause the client application 604 to access the software application 606 via the third party webpage 612. The request 628 and the response 630 thus enable access to the software application 606 at the client 602 without a user of the client 602 initiating or otherwise completing an authentication process for the software application 606.

Regardless of the particular entry point used, the invitation-less unauthenticated access of the software application 606 at the client 602 in the instant apps mode as disclosed herein may result in one or more limitations of the software application experience for the user of the client device, beyond the limitation of functionality as elsewhere described herein. For example, a software application accessed in the instant apps mode may be: prohibited from or otherwise prevent the execution or invocation of REST API calls or the use of webhooks; able to execute or invoke a limited subset of SKD API calls; and/or subject to administrative controls.

In some cases, an environment in which the software application is accessed may be based on a software activity of the user of the client device. For example, where the user of the client 602 is actively participating in a video conference (i.e., where the client 602 is connected to a video conference), the software application 606 may be accessed within a GUI of the video conference (e.g., a GUI of the conferencing software that facilitates the video conference). The client 602 can, for example, determine that the user of the client 602 is actively participating in a video conference based on a client-server connection and a meeting identifier associated with the video conference. In another example, where the user of the client 602 is not actively participating in a video conference, the software application 606 may be accessed within a GUI of the client 602 at which applications made available to the client 602 (e.g., via the platform app marketplace 608) are present. The GUI of the client 602 may, for example, correspond to an “Apps” tab or like section of the client 602.

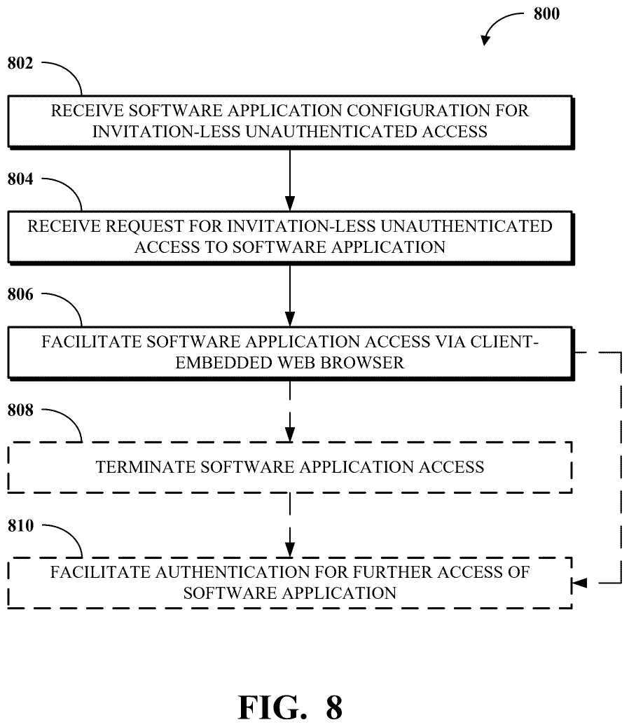

To further describe some implementations in greater detail, reference is next made to examples of techniques which may be performed by or using a system for invitation-less unauthenticated software application access FIG. 7 is a flowchart of an example of a client-side technique 700 for invitation-less unauthenticated software application access. FIG. 8 is a flowchart of an example of a server-side technique 800 for invitation-less unauthenticated software application access.

The technique 700 and/or the technique 800 can be executed using computing devices, such as the systems, hardware, and software described with respect to FIGS. 1-6. The technique 700 and/or the technique 800 can be performed, for example, by executing a machine-readable program or other computer-executable instructions, such as routines, instructions, programs, or other code. The steps, or operations, of the technique 700 and/or the technique 800, or another technique, method, process, or algorithm described in connection with the implementations disclosed herein can be implemented directly in hardware, firmware, software executed by hardware, circuitry, or a combination thereof.

For simplicity of explanation, the technique 700 and the technique 800 are each depicted and described herein as a series of steps or operations. However, the steps or operations of the technique 700 and/or the technique 800 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 7, the technique 700 for invitation-less unauthenticated software application access is shown. At 702, a request for the invitation-less unauthenticated access to a software application is transmitted from a client device. The client device is used by a device user and runs a client application. The client application is associated with a software platform, for example, a UCaaS platform and is used to access software services and related functionality of the software platform. The software application may be software of the software platform, software developed by an entity that operates the software platform, or software external to the software platform (e.g., developed by an entity other than the one that operates the software platform). The request is a request to access the software application within the client application and is transmitted based on a manner by which the client device is in use. For example, transmitting the request can include transmitting the request based on an interaction at the client device with an interactive element output for display within a video conference GUI. In another example, transmitting the request can include transmitting the request based on an interaction at the client device with an interactive element output for display within an application marketplace GUI. In yet another example, transmitting the request can include transmitting, using a web browser of the client application, the request to a URL associated with the software application. In any such case, an interactive element indicating access to the software application is output for display within a GUI at the client device and the request is transmitted based on an interaction with the interactive element.

At 704, permissions for the invitation-less unauthenticated access to the software application are obtained at the client device. The permissions are access-level permissions that configure the client application to access and use a subset of functionality of the software application without first initiating or otherwise completing an authentication process such as OAuth (i.e., independent of any such authentication process being performed or pursued by the client device). The permissions may, for example, be obtained from the software platform or another server to which the request is transmitted from the client device.

At 706, the client device accesses the software application using the obtained permissions. In particular, the client device accesses the software application based on the request, based on the user of the client device being unauthenticated to the software application, and independent of an invitation to access the software application from another device user who is authenticated to the software application. The access of the software application independent of an invitation to access the software application from another device user does not require that such an invitation ever be sent or ever exist—that is, the access may be without regard to any such invitation. The access enables the client device to use a subset of functionality of the software application. For example, the functionality of the software application to which the client device has access may include some or all user experience features, some or all SDK API call functions, and/or the like. The specific functionality to which the client device has access may be based on a configuration asserted for the software application (e.g., by a developer thereof) in the invitation-less unauthenticated mode (i.e., instant apps mode). In some cases, the subset of functionality to which the client device has access may be a same subset of functionality of the software application as is enabled for a guest mode user of the software application. Software application functionality to which the client device does not have access may or may not be visible to the user of the client device.

At 708, optionally, access to the software application at the client device is terminated. For example, the access to the software application may be revoked (e.g., by the software platform, the client application, or a server external to the software platform) after a threshold period of time expires following an initial invitation-less unauthenticated access of the software application by the client device. In another example, the access to the software application may be revoked (e.g., by the software platform, the client application, or a server external to the software platform) after a threshold number of API calls are made in connection with the invitation-less unauthenticated access of the software application by the client device. In yet another example, the access to the software application may be revoked by the user of the client device, such as via a GUI accessible within the client application (e.g., a same GUI as the one via which the request was transmitted or a different GUI).

At 710, optionally, permissions for the authenticated access to the software application are obtained at the client device. In particular, a request may be transmitted, in a similar manner as described above (e.g., via an interaction with a GUI element), for the client device to initiate and complete an authentication process to obtain authenticated access to the software application. In some cases, the permissions for the authenticated access to the software application may be obtained without or otherwise prior to a termination of the invitation-less unauthenticated software application access.

Referring next to FIG. 8, the technique 800 for invitation-less unauthenticated software application access is shown. At 802, a configuration is received for the invitation-less unauthenticated access of a software application. The configuration defines a subset of functionality of the software application to which a user of a client device may, without an invitation or authentication, be able to access. The configuration may be received in one or more formats including, for example, plaintext input from a developer, checklist boxes selected within a software platform form, or the like.

At 804, a request is received for the invitation-less unauthenticated access to the software application from a client device. The request may, for example, be received based on a transmission according to the technique 700 shown in FIG. 7. For example, the request may be received via a web browser embedded within a client application running at the client device.

At 806, access to the software application by the client device is facilitated via the client-embedded web browser. The client-embedded web browser communicates API calls with the server that provides the software application access to enable the use of a subset of functionality of the software application at the client device according to the configuration for the invitation-less unauthenticated access of the software application and based on the request received for the invitation-less unauthenticated access of the software application.

At 808, optionally, access to the software application by the client device is terminated. The access may, for example, be terminated in a manner according to the technique 700 (e.g., by the software platform, the client application, or the like).

At 810, optionally, the authentication of the client device for the further access of the software application is facilitated. Facilitating the authentication of the client device for the further access of the software application can include receiving and processing a second request for the authenticated access to the software application from the client device. In some cases, the facilitation of the authentication for the further access to the software application may be performed without or otherwise prior to a termination of the invitation-less unauthenticated software application access.

The implementations of this disclosure describe methods, systems, devices, apparatuses, and non-transitory computer readable media for enabling the invitation-less and unauthenticated access to software applications at user devices. In some implementations, a method comprises, a non-transitory computer readable medium stores instructions operable to cause one or more processors to perform operations comprising, and/or a system comprises a memory subsystem storing instructions and processing circuitry configured to execute the instructions for: transmitting, by a client device of a first device user who is unauthenticated to a software application, a request to access the software application within a client application at the client device; and accessing, by the client application, the software application based on the request, based on the first device user being unauthenticated to the software application, and independent of an invitation to access the software application from a second device user who is authenticated to the software application.

In some implementations of the method, the non-transitory computer readable medium, and/or the system, transmitting the request to access the software application within the client application at the client device comprises: transmitting the request based on an interaction at the client device with an interactive element output for display within a video conference graphical user interface.

In some implementations of the method, the non-transitory computer readable medium, and/or the system, transmitting the request to access the software application within the client application at the client device comprises: transmitting the request based on an interaction at the client device with an interactive element output for display within an application marketplace graphical user interface.

In some implementations of the method, the non-transitory computer readable medium, and/or the system, transmitting the request to access the software application within the client application at the client device comprises: transmitting, using a web browser of the client application, the request to a uniform resource locator associated with the software application.

In some implementations of the method, the non-transitory computer readable medium, and/or the system, accessing the software application based on the request, based on the first device user being unauthenticated to the software application, and independent of an invitation to access the software application from a second device user who is authenticated to the software application comprises: accessing, within the client application, a subset of functionality enabled for a guest mode user of the software application.

In some implementations of the method, the non-transitory computer readable medium, and/or the system, accessing the software application based on the request, based on the first device user being unauthenticated to the software application, and independent of an invitation to access the software application from a second device user who is authenticated to the software application comprises: accessing, while the client application is connected to a video conference, the software application within a graphical user interface of the video conference.

In some implementations of the method, the non-transitory computer readable medium, and/or the system, accessing the software application based on the request, based on the first device user being unauthenticated to the software application, and independent of an invitation to access the software application from a second device user who is authenticated to the software application comprises: accessing the software application within a graphical user interface of an application marketplace available within the client application.

In some implementations of the method, the non-transitory computer readable medium, and/or the system, the method comprises, the operations comprise, and/or the processing circuitry is configured to execute the instructions for: transmitting, from the client device, a second request to authenticate the first device user to the software application.

In some implementations of the method, the non-transitory computer readable medium, and/or the system, the request is transmitted within a webpage associated with the software application.

In some implementations of the method, the non-transitory computer readable medium, and/or the system, the client application is software of a unified communications as a service platform and the software application is software external to the unified communications as a service platform.

In some implementations of the method, the non-transitory computer readable medium, and/or the system, the method comprises, the operations comprise, and/or the processing circuitry is configured to execute the instructions for: outputting, for display within a graphical user interface of the client application, an interactive element indicating access to the software application within the client application, wherein the request is transmitted based on an interaction with the interactive element.

In some implementations of the method, the non-transitory computer readable medium, and/or the system, the software application is accessed within a video conference graphical user interface output via the client application.

In some implementations of the method, the non-transitory computer readable medium, and/or the system, the software application is accessed within an application marketplace graphical user interface output via the client application.

In some implementations of the method, the non-transitory computer readable medium, and/or the system, the request is transmitted based on an interaction at the client device with a user interface element output within a graphical user interface of a video conference, an application marketplace, or a webpage associated with the software application.

In some implementations of the method, the non-transitory computer readable medium, and/or the system, the software application is accessed via a video conference or an application marketplace.

In some implementations of the method, the non-transitory computer readable medium, and/or the system, the access is limited to a subset of functionality enabled for a guest mode user of the software application.

In some implementations of the method, the non-transitory computer readable medium, and/or the system, the client application is configured to open at the client device to enable the access to the software application.

In some implementations of the method, the non-transitory computer readable medium, and/or the system, the software application is external to a unified communications as a service platform associated with the client application.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
transmitting, by a client device of a first device user who is unauthenticated to a software application, a request to access the software application within a client application at the client device; and
accessing, by the client application, the software application based on the request, based on the first device user being unauthenticated to the software application, and independent of an invitation to access the software application from a second device user who is authenticated to the software application.

2. The method of claim 1, wherein transmitting the request to access the software application within the client application at the client device comprises:
transmitting the request based on an interaction at the client device with an interactive element output for display within a video conference graphical user interface.

3. The method of claim 1, wherein transmitting the request to access the software application within the client application at the client device comprises:
transmitting the request based on an interaction at the client device with an interactive element output for display within an application marketplace graphical user interface.

4. The method of claim 1, wherein transmitting the request to access the software application within the client application at the client device comprises:
transmitting, using a web browser of the client application, the request to a uniform resource locator associated with the software application.

5. The method of claim 1, wherein accessing the software application based on the request, based on the first device user being unauthenticated to the software application, and independent of an invitation to access the software application from a second device user who is authenticated to the software application comprises:
accessing, within the client application, a subset of functionality enabled for a guest mode user of the software application.

6. The method of claim 1, wherein accessing the software application based on the request, based on the first device user being unauthenticated to the software application, and independent of an invitation to access the software application from a second device user who is authenticated to the software application comprises:
accessing, while the client application is connected to a video conference, the software application within a graphical user interface of the video conference.

7. The method of claim 1, wherein accessing the software application based on the request, based on the first device user being unauthenticated to the software application, and independent of an invitation to access the software application from a second device user who is authenticated to the software application comprises:
accessing the software application within a graphical user interface of an application marketplace available within the client application.

8. The method of claim 1, comprising:
transmitting, from the client device, a second request to authenticate the first device user to the software application.

9. The method of claim 1, wherein the request is transmitted within a webpage associated with the software application.

10. The method of claim 1, wherein the client application is software of a unified communications as a service platform and the software application is software external to the unified communications as a service platform.

11. A non-transitory computer readable medium storing instructions operable to cause one or more processors to perform operations comprising:
transmitting, by a client device of a first device user who is unauthenticated to a software application, a request to access the software application within a client application at the client device; and
accessing, by the client application, the software application based on the request, based on the first device user being unauthenticated to the software application, and independent of an invitation to access the software application from a second device user who is authenticated to the software application.

12. The non-transitory computer readable medium of claim 11, the operations comprising:
outputting, for display within a graphical user interface of the client application, an interactive element indicating access to the software application within the client application, wherein the request is transmitted based on an interaction with the interactive element.

13. The non-transitory computer readable medium of claim 11, wherein the software application is accessed within a video conference graphical user interface output via the client application.

14. The non-transitory computer readable medium of claim 11, wherein the software application is accessed within an application marketplace graphical user interface output via the client application.

15. A system, comprising:
a memory subsystem; and
processing circuitry configured to execute instructions stored in the memory subsystem to:
transmit, by a client device of a first device user who is unauthenticated to a software application, a request to access the software application within a client application at the client device; and
access, by the client application, the software application based on the request, based on the first device user being unauthenticated to the software application, and independent of an invitation to access the software application from a second device user who is authenticated to the software application.

16. The system of claim 15, wherein the request is transmitted based on an interaction at the client device with a user interface element output within a graphical user interface of a video conference, an application marketplace, or a webpage associated with the software application.

17. The system of claim 15, wherein the software application is accessed via a video conference or an application marketplace.

18. The system of claim 15, wherein the access is limited to a subset of functionality enabled for a guest mode user of the software application.

19. The system of claim 15, wherein the client application is configured to open at the client device to enable the access to the software application.

20. The system of claim 15, wherein the software application is external to a unified communications as a service platform associated with the client application.
